(19) United States
(12) Patent Application Publication
(10) Pub. No.: US 2009/0317594 A1
(43) Pub. Date: Dec. 24, 2009

(54) Mat-formed panel

(76) Inventor: Travis Cox, Poynette, WI (US)

Correspondence Address: LATHROP & CLARK LLP, 740 REGENT STREET SUITE 400, P.O. BOX 1507, MADISON, WI, 537011507, US

(21) Appl. No.: 12/456,779

(22) Filed: Jun. 23, 2009

Related U.S. Application Data
(60) Provisional application No. 61/074,836, filed on Jun. 23, 2008.

(51) Int. Cl. B32B 3/00; B32B 37/02

(52) U.S. Cl. 428/156; 156/256

(57) ABSTRACT

A novel wood product is manufactured by removing a layer of material from an original outer surface or face of a mat-formed product such as, for example, an oriented strand board (OSB) panel. Contrary to expectations, the exposed surface resulting from removing the layer from the original outer surface or face of the mat-formed panel has an appearance that is drastically different from, and visually appealing relative to, the unaltered original outer surface or face of the mat-formed panel.

This application claims priority to U.S. Provisional Application 61/074,836, filed Jun. 23, 2008, which is incorporated herein by reference in its entirety.

### BACKGROUND

1. Field of the Invention

This invention is directed to wood paneling and other wood products made from a mat-formed panel.

2. Background of the Invention

Mat-formed panels are engineered wood panels that include individual layers of wood pieces arranged in mats, or in a mattress-like configuration. Types of mat-formed panels include, for example, oriented strand board (OSB), waferboard and chip board. The differences between the various types of mat-formed panels lies in the way the wood pieces are made (e.g., dimensions of the wood pieces) and in the way the wood pieces are used to make the panel. In some cases, terms for different mat-formed panels are used interchangeably and/or different terms for the same physical structure are used interchangeably or are preferred by different market segments or in different regions. For example, OSB is sometimes called oxboard, waferboard, chip board, flake board, blandex or sterling board.

OSB panels, as well as other mat-formed panels, are typically produced by compressing and bonding layers of wood strips with wax and resin adhesives. In OSB panels, the strands in each layer are laid out so that they are flat to the plane of the panel but in a desired orientation or angle (or a desired range of orientations or angles) to the long side of the panel within that plane. The interior layers of wood strips are typically cross-oriented, i.e., the wood strips of each layer are oriented along the plane of the panel but the interior layers are typically oriented at an angle to the adjacent and/or the exterior layers, to add strength to the final product. Typically, but not necessarily, internal layers of wood strips are oriented at approximately a ninety degree angle to the external layers of wood strips.

OSB may be advantageous over other engineered wood products, such as plywood, for many reasons. For example, OSB panels can be made from small diameter, round wood logs that are cut into small strands or chips. The trees that are the source for OSB are generally small-diameter, fast-growing trees and thus are a quickly renewable source. Additionally, OSB panels can be manufactured using waste or scrap material from other manufacturing or construction processes. Being an engineered wood, OSB can also be manufactured to have many different desired characteristics (e.g., thickness, density, panel size, etc.).

### SUMMARY OF THE DISCLOSED EMBODIMENTS

There is a growing demand for wood products of varying styles and constructions. A unique style of wood product can be manufactured by removing a top portion of a mat-formed panel, such as, for example, an OSB panel, such that an inner layer of wood is exposed. Contrary to expected results, removing the top portion of the mat-formed panel results in a random, marbled appearance that offers a unique aesthetic appearance (e.g., each panel will look different and unique compared to any other panel), rather than producing a predictable uniform appearance that is similar to the original outer surface of the mat-formed panel, in which each panel has a generally uniform and consistent, although individual, appearance.

This invention provides a novel wood product made from one or more mat-formed panels, such as, for example, OSB panels, having at least a top portion of the mat-formed panel removed.

This invention separately provides a process for manufacturing a novel wood product by removing at least a top portion of material from a mat-formed panel, such as, for example, an OSB panel.

In various exemplary embodiments, a mat-formed panel, such as, for example, an OSB panel, is milled, cut or sanded to remove a desired amount of material from the top surface of the panel. By removing a desired amount of material from the top surface of the mat-formed panel, an internal cross-sectional plane is exposed as a new top surface of the panel. The resulting cross-sectional plane has a substantially different appearance than the original outer surface, such that the exposed cross-sectional plane is commercially usable as an exposed building surface. That is, a panel having an exposed cross-sectional place as its outer surface can be marketed as flooring, wall paneling or any other appropriate wood product in competition with conventional flooring options, in competition with wall board or conventional wood paneling products and/or in competition with any other appropriate wood product. Stated differently, a differently, a panel having an exposed cross-sectional plane has, to a commercially significant portion of the purchasing public, a sufficiently aesthetically-desirable appearance that this panel is considered for purchase and installation into the purchaser's building as an exposed surface. In various exemplary embodiments, a sufficiently aesthetically-desirable appearance may imitate another material. For example, in various exemplary embodiments, the exposed cross-sectional plane approximates or closely resembles a marble texture or marled wood.

In various exemplary embodiments, the initial mat-formed panel is specifically manufactured thicker than desired so that the resulting panel will have a desired thickness, such as a standard panel thickness, after the top portion of material is removed. In various other exemplary embodiments, the initial mat-formed panel may be manufactured with a thickness that is approximately twice a desired thickness, such that the panel can be cut in half through the thickness of the panel, resulting in two panels with exposed cross-sectional planes.

In various exemplary embodiments, at least about 1/32 of an inch (about 0.8 mm) of material is removed from the top surface of the mat-formed panel. In some exemplary embodiments, up to about ⅛ of an inch (about 3 mm), or even more, of the material is removed from the top surface of the mat-formed panel. In various exemplary embodiments, an amount, such as a uniform thickness of material, is removed from both a top surface and a bottom surface of a mat-formed panel, resulting in a panel according to this invention having the desired visual appearance on two opposing surfaces.

It should be appreciated that the initial thickness of the mat-formed panel may vary and as such, the thickness of the material removed may vary and/or the resulting thickness of the modified panel may vary. In some cases, the thickness of the amount of material to be removed will be dictated by the thickness of the mat-formed panel and/or the thickness of the layers of wood used to make the mat-formed panel or vice versa.

It should also be appreciated that modified mat-formed panels according to this invention, whether manufactured according to any of the exemplary embodiments outlined below and/or using any other embodiments, can be used, as outlined above, to make a variety of products, including, for example, floor panels of varying widths, lengths, thicknesses, colors and/or installation designs; box car siding-style wall and/or ceiling panels; wainscoting and other wall moulding; wall and/or ceiling panels; millwork, including base, casing, crown and/or other mouldings of varying widths, thicknesses, lengths, styles and colors; cabinets and cabinet doors; bar tops; counter tops and other wood products. In general, any desirable known or later-developed wood product can be manufactured in whole or in part using a wood product according to this invention.

These and other features and advantages of various exemplary embodiments of systems and methods according to this invention are described in, or are apparent from, the following detailed descriptions of various exemplary embodiments of various devices, structures and/or methods according to this invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Various exemplary embodiments of the systems and methods according to this invention will be described in detail, with reference to the following figures, wherein:

FIG. 1 is a top plan view of a portion of a standard OSB panel;

FIG. 2 is a partial schematic cutaway of a standard OSB panel;

FIG. 3 is a top plan view of a first exemplary embodiment of an altered OSB panel according to this invention;

FIG. 4 is a top plan black and white photograph of one portion of a standard OSB panel;

FIG. 5 is a top plan black and white photograph of a first portion of a second exemplary embodiment of an altered OSB panel according to this invention;

FIG. 6 is a top plan black and white photograph of a second portion of the second exemplary embodiment of the altered OSB panel according to this invention after being treated;

FIG. 7 is a top plan color photograph of the portion of the standard OSB panel shown in FIG. 4;

FIG. 8 is a top plan color photograph of the first portion of the second exemplary embodiment of the altered OSB panel shown in FIG. 5; and

FIG. 9 is a top plan color photograph of the second portion of the second exemplary embodiment of the altered and treated OSB panel shown in FIG. 6.

### DETAILED DESCRIPTION OF EXEMPLARY EMBODIMENTS

In general, for the purposes of the following description, a flake is considered to be any thin, generally rectangular-shaped, cut of wood with minimal thickness compared to its length and width. A flake is generally cut from the side of a clean, debarked hardwood or softwood log such that a plane of the flake parallels the grain of the wood and that the grain of the wood runs down the length of the flake. Flakes are generally longer than they are wide. Wafers are a subset of flakes, where the length of the flake is at least about 1¼ inches long (about 32 mm). Strands are a further subset of wafers, where the length of the wafer is at least twice its width. In the following descriptions, it should be appreciated that the terms flake, wafer and strand may be interchangeable and that any descriptions referring to strands may also include wafers or flakes, even though such wafers and flakes are not literally strands. Similarly, any descriptions that refer to wafers may include flakes, even though such flakes are not literally wafers.

Further, it should be appreciated that, in various exemplary embodiments intended to use strands, such strands may include wafers or flakes, even though such wafers and flakes are not literally strands. Likewise, in various exemplary embodiments intended to use wafers, such wafers may include flakes, even though such flakes are not literally wafers.

The following definitions of various terms used in the following detailed description are used within the structured board industry:

Core—the center part of an OSB (or other mat-formed) panel.

Direction of Orientation—the predominant direction of a layer of strands, wafers or flakes.

Face and Back—the upper and lower surfaces of a panel (e.g., a top surface and a bottom surface of the panel).

Former—a mechanism for making a layer of strands into a mat of a predetermined thickness, which, after hot pressing, will give a panel a desired thickness.

Forming—a method of making a layer of strands into a mat of a predetermined thickness, which, after hot pressing, will give a panel a desired thickness.

Mat-Formed—formation of a panel of strands, wafers or flakes in a mat or mattress-like form prior to pressing.

Oriented Strand Board (OSB)—a type of mat-formed panel with oriented face and back strands, possibly cross-oriented core strands, and made of strands whose length is at least twice their width.

Pressing—the act of squeezing a panel together.

Strand—wafer whose length is minimum twice its width.

Wafer—a wood flake produced by a waferizer with a minimum length of 1¼″, a controlled width and controlled, relatively thin thickness. A wafer is essentially flat with the grain running in the direction of the length.

Waferboard—an exterior bonded structural panel product made from wafers.

Forming is a stage in the manufacturing of OSB and waferboard panels. This stage sets the uniformity of physical properties throughout the panel. It also determines whether wafers in the panel are random (e.g., as in waferboard) or oriented (e.g., as in OSB). The forming machine typically has a number of bins with live bottoms comprising rotating disc-type screws. The strands or wafers are discharged from the bins over these screws onto a traveling conveyor belt or forming box. The rate of discharge is closely coordinated with the rate of movement of the box or belt to give the correct thickness to the resulting mat or individual layers of the mat. Depending on the design and position of the discharge screws, the strands or wafers fall on the belt in a random or oriented manner. Orientation occurs when the spaces between the screws discs are almost vertical so that the strands must fall from the box in the direction of the screw rotation.

Waferboard is a first generation engineered product made from wafers cut from round-wood. The wafers are bonded with a waterproof phenolic resin which combines with the wafers to help provide strength, rigidity and moisture resistance to the finished panel. The wafers, with their uniform thickness and controlled length (at least 30 mm or 1¼″), help give waferboard its strength and stiffness. A strand is the descriptive term for a narrow wafer. By definition, the length of a strand should be at least twice as long as its width. In Oriented Strand Board (OSB) panels, the wafers or strands are deliberately aligned or oriented, at least within each individual layer if there is more than one layer. Relative to waferboard, this improves various structural qualities in the direction of alignment while reducing them slightly in the perpendicular direction.

Whether used in waferboards or OSBs, wafers, which may include strands, are generally sliced from the side of clean, debarked, hardwood logs so that the plane of the wafer parallels the grain of the wood. However, it should be appreciated that the wafers in a given panel may be obtained from softwood logs and/or other wood sources in place of or in addition to hardwood logs. These freshly cut wafers are then dried to a moisture content of approximately 3%. They are then screened. “Fines” (small flakes) are removed and together with the bark, are generally used for energy production. The wafers are then blended with special phenolic resin and some wax to guarantee good bonding. The wafers, now coated with the phenolic resin, pass through formers, which lay down a continuous mat (or sheet) of wafers in a “random” pattern on to a conveyor system.

It should be appreciated that the “random” pattern of the continuous mat of wafers and/or strands discussed in the above-outlined description of OSB and waferboard panels does not imply that the wafers and/or strands necessarily have random orientation or that the resulting mat has random thickness or construction. Rather, the random placement simply means that the wafers and/or strands are not selectively placed in their respective locations throughout the mat.

Waferboard and OSB both have engineering characteristics which give each panel advantages over the other, (and other types of panels) for specific applications. Waferboard by definition is made from wafers. OSB is made from strands. In OSB, the wafers are, by definition, oriented (aligned). Waferboard can be oriented (OWB or Oriented Wafer Board) but is generally engineered with wafers laid in a random orientation. Random oriented waferboards have approximately equal strength in both directions, both along and across the panel. This has advantages in applications such as wall sheathing or packaging where strength is required in both directions. OSB (and OWB) is generally stronger in the long (e.g., oriented) direction than in the perpendicular (e.g., cross-oriented) direction. OSB has advantages for stiffness and rigidity across supports in such applications as roof sheathing or sub-flooring. Additionally, it should be appreciated that OSB is a subset of waferboard, in that OSB is made out of strands, which are a subset of wafers.

It should be appreciated that, in the below-outlined exemplary embodiments, while the description focuses on OSB panels, in various exemplary embodiments, the OSB panels may be replaced with any other mat-formed panels. The use of OSB panels in the following detailed descriptions of certain exemplary embodiments is for simplifying the explanation and is not intended to be limiting in any way.

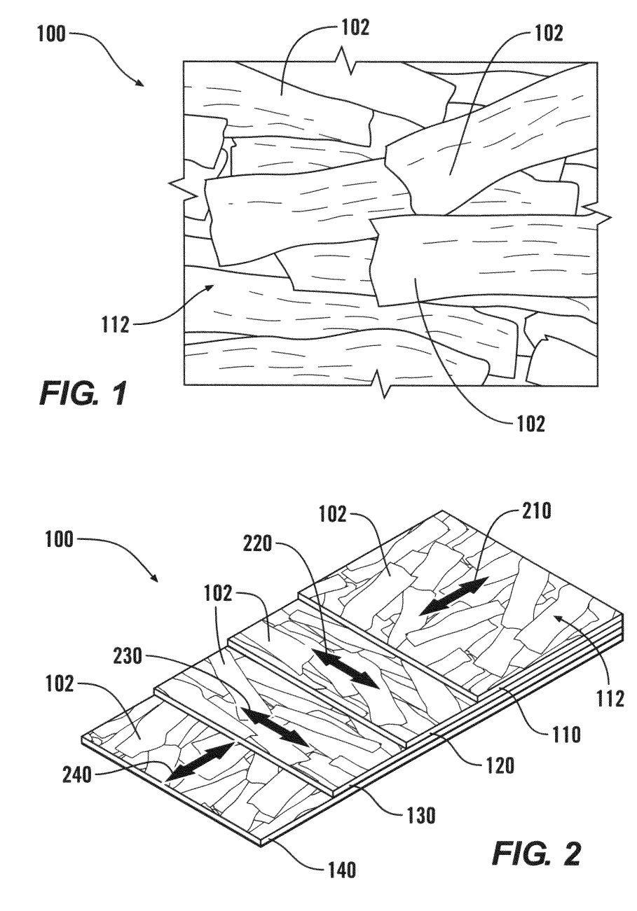

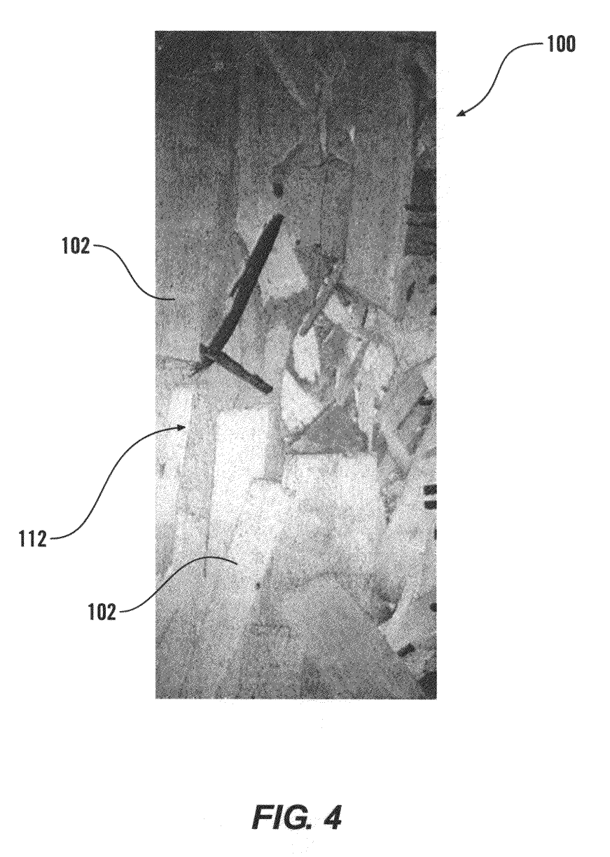

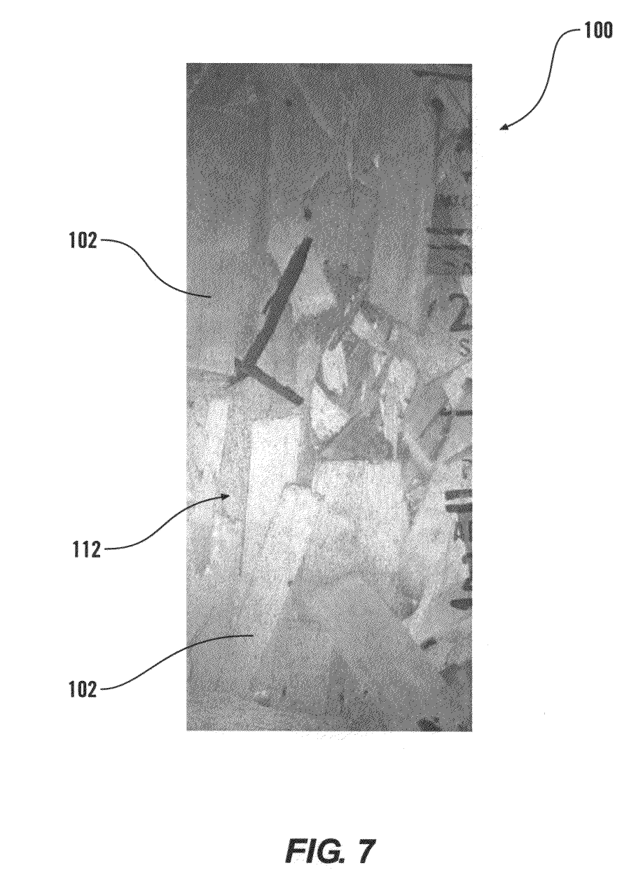

FIGS. 1, 4 and 7 are a plan view, a plan black and white photograph and a plan color photograph of a portion of the top surface or face of a standard, unaltered OSB panel 100. As shown in FIGS. 1, 4 and 7, the unaltered OSB panel 100 has a top surface or face 112 that includes multiple strands 102 of varying length and approximately uniform width and thickness.

The OSB panel 100 is constructed using directionally oriented strands 102 of wood, as opposed to directionally randomly oriented or arranged wood particles, wafers or chips, and includes individual layers of wood strands 102 that each have a generally uniform thickness. More specifically, during manufacture of each layer of strands 102, the strands 102 are generally directionally aligned with each other within that layer. Additionally, each layer of strands 102 is approximately uniform in thickness. As indicated above, before (and/or possibly during and/or after) each strand 102 is added to a given layer, that strand 102 is combined with wax and/or resin adhesives. Once the various layers are completed, the multiple layers are subjected to high temperature and pressure to compress the layers into the uniform panel 100. The high pressure and heat compress the strands 102 and melt and/or activate the wax and/or resin adhesives. The melted and/or activated wax and/or resin adhesives bond the compressed strands 102 together to form the unitary panel 100.

FIG. 2 is a partial schematic cutaway of the exemplary OSB panel 100 before being compressed and heated and/or as the panel 100 would be expected to appear if it were possible to deconstruct the panel 100 into its formative layers. As shown in FIG. 2, the OSB panel 100 has several layers of wood strands 102. In this example, the OSB panel has four layers of wood strands 102, including a top layer 110 that will provide the top surface or face 112, two internal layers 120 and 130 and a bottom layer 140 that will provide a bottom surface or back. Each layer 110-140 is made of oriented strands 102 of wood aligned along the plane of the OSB panel 100. In the top and bottom layers 110 and 140, the strands 102 are oriented in a first direction, indicated by arrows 210 and 240, while, in the internal layers 120 and 130, the strands 102 are oriented in a second direction, indicated by arrows 220 and 230, which is roughly perpendicular to the first direction 210/240.

It should be appreciated that, while the exemplary OSB panel 100 shown in FIG. 2 has four layers 110, 120, 130 and 140, an OSB panel, or other mat-formed panel, may be made with any number of layers of strands. Additionally, each layer of strands may be multiple strands thick and thus the layers may not have uniform thickness. It should also be appreciated that the oriented strands 102 need not be perfectly aligned in each layer. That is, the strands 102 are generally aligned along or relative to a given direction. However, each individual strand 102 may deviate from the desired orientation to a limited degree (i.e., by a given angle or level of tolerance). For example, the strands 102 in any particular layer may be aligned such that they lie generally (or more or less) parallel to each other without requiring that any two strands 102 actually are parallel to each other. Likewise, one or more layer of strands 102 may include strands that are randomly arranged as opposed to being oriented relative to a single direction.

As outlined above and as shown in FIG. 2, the OSB panel 100 has several layers 110-140 of generally uniformly or similarly thick strands 102. The layers 110-140 are provided on top of each other and pressed together when forming the OSB panel 100. Had it been given any thought (the inventor is not aware of any discussions of the internal structure of a flake-based panel after being pressed and heated) the inventer believes it would have been assumed that the layers 110-140 would remain relatively intact during the forming process, with the layered strands 102 remaining generally flat relative to each other and the plane of the panel 100. That is, it would have been assumed that, as the layers 110-140 and the individual strands 102 within each layer were compressed, each strand 102 would be proportionally compressed. That is, it would have been assumed that the end result would be a panel of uniformly compressed rectangular strands 102 stacked on top of, next to and/or overlapping each other, such that the compressed and heated panel would be physically similar to the uncompressed panel, except for the height or thickness being reduced.

As such, it would have been assumed that there would be little or no variation in the appearance of a planar cross-sectional view, relative to the appearance of the top surface 112, as shown in FIGS. 1, 4 and 7, regardless of the depth of the cross-section and regardless of whether the cross-section was taken before or after heating and compressing. It would have been assumed that a planer cross-sectional surface within the OSB panel 100 would generally have the same appearance as the top surface 112 of the panel 110. That is, at every depth, it would have been expected that a generally uniform layer of strands 102 would be visible, albeit possibly oriented in different directions depending on the depth of the cross sectional cut, due to the cross-orientation of the layers 110-140 of the strands 102 used to make the OSB panel 100. It would also have been expected that individual strands 102 would be easily and/or readily distinguishable at any depth within the panel 100.

Furthermore, it should be noted that the strands 102 are rectangular in shape, or more precisely, the strands 102 are rectangular prisms with minimal thickness compared to their width and length. It should also be noted that a cross section through a rectangular prism taken at any angle will result in a surface that is a rectangle or a triangle. Thus even if the cross-section were taken at an angle to the plane of the OSB panel 100, it would have been assumed that the uniform thickness and alignment of the strands 102 would result in a uniform pattern of whole or partial strands 102 in the shape of rectangles and triangles. The expected appearance of a planer cross-section can be seen in FIG. 2 as the surfaces of the uncompressed internal layers 120 and 130.

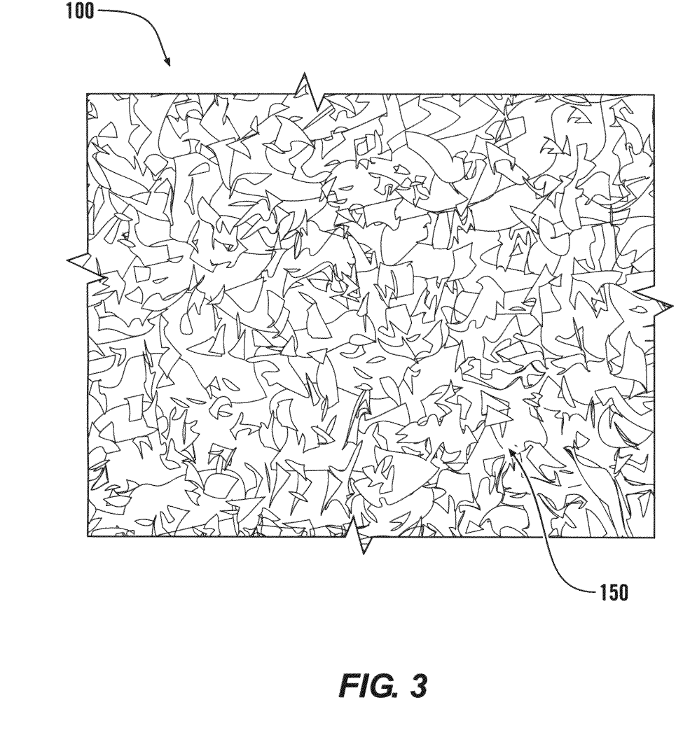

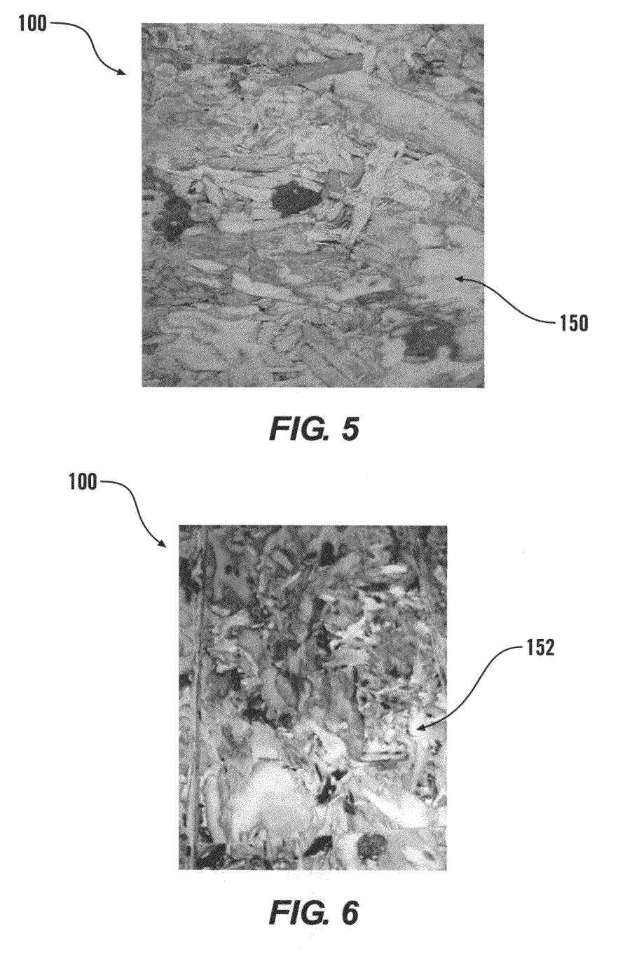

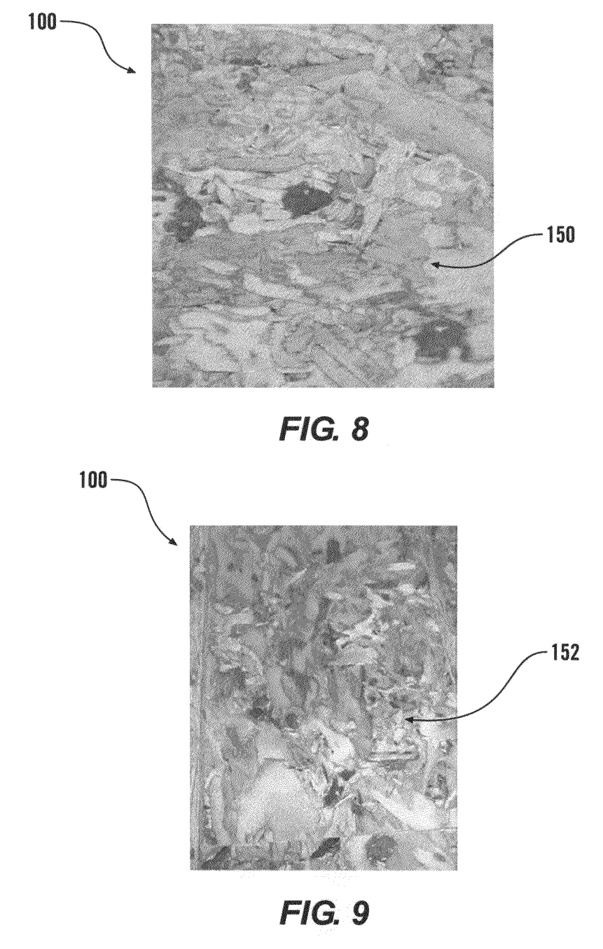

However, as shown in FIGS. 3, 5 and 8, it has been unexpectedly found that by removing a layer of material from the top surface or face 112 of the OSB panel 110, an internal surface 150 is exposed that has a unique, random visual appearance. The exposed internal surface 150 has a unique, unexpected appearance in that, rather than a uniform layer of oriented strands 102, similar to the top surface or face 112, wherein the individual strands 102 are easily distinguishable, a random appearance comprising various of parts of the strands 102 is found. The random appearance of the internal surface 150 is drastically different than the appearance of the top surface or face 112. The random appearance of the internal surface 150 may be described as a burl or marled appearance, similar to wood from a tree burl or marl. The individual strands 102 are not easily distinguishable and are intertwined together in a random swirling fashion and may be strands 102 from various ones of the layers 110-140. The partial strands 102 do not represent the expected rectangular and/or triangular patterns.

FIGS. 6 and 9 show an exemplary embodiment of an altered OSB panel 100 according to this invention that has been treated with a sealant, varnish or other product. As shown in FIGS. 6 and 9, after removing the layer of material from the top surface or face 112 of the OSB panel 100, the newly exposed surface 150 of the OSB panel 100 may be treated with sealants, varnishes or other products to, among other things, alter and/or enhance the appearance of the newly exposed surface 150 of the OSB panel 100 and/or to protect the OSB panel 100 from external elements, such as moisture or wear. For example, treating the exposed surface 150 with a stain may make the individual strands 102 more distinguishable or less distinguishable, may emphasize the borders between strands 102 over the strands 102 themselves or vice versa, may be absorbed differently by the different exposed strands 102 (e.g., depending on the direction of the grain) and/or the like. Different compositions and/or color(s) for the treating material (e.g., stain, varnish, sealant, etc) may be selected to obtain desired on or more of these and/or any other known or later-developed effects to obtain a final panel 100 according to this invention with a desired appearance.

It should be appreciated that boards of OSB, other OSB products and/or other mat-formed products, rather than OSB panels, can be used with the above-outlined process to make the above-outline product. It should be appreciated that, OSB or other mat-formed panels can be cut before and/or after being treated as outlined above to provide the desired shape of a final OSB or mat-formed product. In various exemplary embodiments, the OSB panels are cut into uniform boards for installing as flooring. In various exemplary embodiments, the OSB panels or boards are cut with an opposing tongue and groove design on opposite long surfaces of the panels or board. In various exemplary embodiments, the OSB panels or boards and/or other mat-formed products are treated with chemicals to, for example, improve water resistance, improve mold resistance, improve durability, improve strength and/or to alter any other chemical and/or physical property and/or appearance of the wood. In general, the OSB products and/or mat-formed products may be treated and/or shaped by any number of steps before and/or after being altered to expose an internal surface as outlined above.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A method of making a mat-formed product of manufactured wood, comprising;
obtaining a mat-formed product, having a first surface; and
removing at least the first surface of the product to expose at least an interior surface of the product.

2. The method of claim 1, wherein the first surface is a generally planar surface.

3. The method of claim 1, wherein obtaining a mat-formed product comprises forming a mat-formed product.

4. The method of claim 3, wherein forming a mat-formed product comprises:
cutting source wood into strands of generally uniform shape;
combining the strands with adhesive comprising at least one of wax and resin;
distributing a first plurality of strands into a first layer;
distributing at least a second plurality of strands into at least a second layer, the second layer position over the first layer;
distributing a third plurality of strands into a third layer over the at least second layer;
applying heat and pressure to at least the first, second and third layers to compress the layers and activate the adhesive to form the mat-formed product.

5. The method of claim 4, wherein:
distributing the first plurality of strands into the first layer further includes aligning the first plurality of strands in a first direction;
distributing the at least second plurality of strands into the at least second layer includes aligning the second plurality of strands in a second direction that is different than the first direction; and
distributing the third plurality of strands into the third layer includes aligning the third plurality of strands in the first direction.

6. The method of claim 1, wherein the mat-formed product further includes a second surface opposite the first surface, the method further comprising removing the second surface of the product to expose a second interior surface of the mat-formed product.

7. The method of claim 6, wherein the second surface is a generally planar surface.

8. The method of claim 1, wherein removing at least the first surface comprises removing at least about ⅛ of an inch of material from the top surface of the mat-formed product.

9. The method of claim 1, wherein obtaining a mat-formed product comprises obtaining a mat-formed panel.

10. A wood product comprising a mat-formed product, wherein a portion has been removed from a first surface of the mat-formed product to expose an interior surface of the mat-formed product, the interior surface of the mat-formed product having an appearance that is substantially different than the first surface.

11. The wood product of claim 10, wherein the portion is generally about ⅛ of an inch thick.

12. The wood product of claim 11, wherein the portion has a uniform thickness of at least about ⅛ of an inch.

13. The wood product of claim 10, wherein a second portion has been removed from a second surface opposite the first surface of the product.

14. The wood product of claim 13, wherein the second portion is generally about ⅛ of an inch thick.

15. The wood products of claim 14, wherein the second portion has a uniform thickness of at least about ⅛ of an inch.

16. The wood product of claim 13, wherein the second surface is a generally planar surface.

17. The wood product of claim 10, wherein the mat-formed product is an oriented strand board panel.

18. The wood product of claim 10, wherein the first surface is a generally planar surface.
